(19) United States
(12) Patent Application Publication
(10) Pub. No.: US 2025/0340081 A1
(43) Pub. Date: Nov. 6, 2025

(54) LIQUID APPLICATOR DEVICE

(71) Applicant: FLOCON, Inc., Woodstock, IL (US)

(72) Inventors: Stephan M. Ballot, Barrington Hills, IL (US); Fred M. Ekstrom, Algonquin, IL (US)

(21) Appl. No.: 19/194,163

(22) Filed: Apr. 30, 2025

Related U.S. Application Data
(60) Provisional application No. 63/641,079, filed on May 1, 2024.

(51) Int. Cl. B43K 5/18; B43K 5/17

(52) U.S. Cl. CPC B43K 5/1845; B43K 5/17

(57) ABSTRACT

A liquid applicator device is disclosed for dispensing a liquid. A dispensing mechanism defines a valve body hollow. The dispensing mechanism receives the liquid from a liquid container. A closure engages with the liquid container. An applicator tip slidably engages within the closure. A flared peripheral shoulder is coupled to a valve element. The flared peripheral shoulder is impressed against the valve body hollow for preventing the liquid from exiting the dispensing mechanism. The flared peripheral shoulder is displaced for permitting the flow of the liquid from the dispensing mechanism and to the applicator tip. In a first embodiment of the invention, the flared peripheral shoulder includes a non linear protrusion for preventing leakage of the liquid from the dispensing mechanism. In a second embodiment of the invention, a valve flow regulator is coupled to the valve element for controlling the flow of the liquid from the dispensing mechanism.

### CROSS-REFERENCE TO RELATED APPLICATIONS

This application claims benefit of U.S. Patent Provisional application No. 63/641,079 filed May 1, 2024. All subject matter set forth in provisional application No. 63/641,079 is hereby incorporated by reference into the present application as if fully set forth herein.

### BACKGROUND OF THE INVENTION

### Field of the Invention

This invention relates to the dispensers and more particularly, this invention relates to a liquid applicator device for dispensing a liquid on a surface.

### Background of the Invention

Various types of liquid applicator devices have been devised for dispensing a liquid. Some of these liquid applicator devices were used for dispensing an applicator liquid for writing with ink, dye or paint. Among such devices were fountain pens, ball point pens, felt tip pens as well as other types of liquid applicator devices and the like.

These liquid applicator devices of the prior art have receiving wide acceptance due in great measure to the convenience of the device. Furthermore, these liquid applicator devices of the prior art had the ability to retain a large quantity of applicator liquid and the ability to supply additional applicator liquid from a liquid container to an applicator tip at the discretion of the user. In addition, the liquid applicator devices were not limited to the dispensing of only writing liquid such as paints, dyes and the like but are capable of dispensing a large variety of applicator liquids including chemicals, perfumes, lubricants and the like.

Continuing efforts have been made in the past to improve the design of the liquid applicator devices. The improve the design of the liquid applicator devices have concentrated on the liquid dispensing mechanism and for improving the communication of the liquid from the liquid container to the applicator tip for dispensing the applicator liquid onto a surface. In one example of a liquid applicator device, an applicator liquid flows into a fiber applicator tip only when the liquid applicator device is held upside down and the fiber applicator tip is depressed by a surface to be coated by the applicator liquid.

U.S. Pat. No. 1,857,467 to Marsh discloses a fountain marker comprising a main reservoir adapted to contain fluid with an end wall for said reservoir having an opening therethrough. An auxiliary reservoir is arranged to receive fluid through the opening with a valve opening and closing the discharge outlet. A stem connected to the valve extends through the opening. The fluid is admitted from the main reservoir to the auxiliary reservoir when the valve is closed and is prevented from flowing from the main reservoir to the auxiliary reservoir when the valve is in an open position. A spring holds the valve closed with an applicator tip attached to the valve.

U.S. Pat. No. 2,024,413 to Witt discloses a fountain brush comprising an elongated hollow handle forming a liquid reservoir. A cap is secured to the forward end of the handle having an elongated frusto-conical valve seat and a closure cap on the opposite end of the handle. An elongated conical valve is received in the valve seat. An inwardly projecting stem is formed on the rear end of the valve. An outwardly projecting shank is carried by the forward end of the valve. A cross-head on the stem having an ends is slidably engaged with the inner face of the hollow handle. A contractile coil spring is disposed about the stem having one end anchored to the stem and the other end being anchored in place between the forward cap and handle. A brush-head on the shank and a conical deflector formed on the brush-head are arranged in facing relation to the valve for receiving liquid therefrom.

U.S. Pat. No. 2,210,662 to Garvey discloses a writing instrument comprising a reservoir for the writing fluid and a valve tiltable in different directions to control the discharge of fluid from the reservoir. A tiltable tip holder is united with and extends from the tiltable valve with the tiltable tip holder having an internal screw thread. A writing tip is made of a yieldable absorbent material and is screwed into the internal thread to project from the lower end of the tip holder. The writing tip is adjustable longitudinally on the screw thread in response to rotary movements of the tip independently of the tip holder. A means limits the rotary movements of the tip holder and includes a tiltable abutment carried by and tiltable with the united valve and tip holder and a fixed abutment co-operating with the tiltable abutment.

U.S. Pat. No. 2,330,053 to Herb discloses a fountain applicator comprising a fluid containing reservoir and a marking nib and means operable by pressure on the nib in excess of that required for marking therewith for forcing fluid from the reservoir to the nib.

U.S. Pat. No. 3,468,611 to Ward discloses a liquid applicator having a tubular member of flexible side wall construction. A porous applicator nib and valve means control the flow of liquid from the tubular member to the applicator nib.

U.S. Pat. No. 4,976,564 to Fukuoka et al. discloses an implement for applying a liquid comprising a container having an opening at a front end and a front tube attached to the container forward end. A hollow accommodating member has a chamber in an interior and formed with a rearward communication hole and a forward communication hole for holding the chamber in communication with the interior of the container and the interior of the front tube respectively. A liquid feed member is accommodated in the chamber and is movable axially thereof. A biased end valve is disposed inside the front tube to provide a liquid retaining portion inside the front tube around the end valve for closing the forward end opening of the front tube. An applicator having a capillary action extends through the forward end opening of the front tube and is secured to the front end of the end valve.

U.S. Pat. No. 4,984,923 to Ota discloses an operating member inserted in the middle cylinder to be movable backward and forward in the axial direction. A valve mechanism is provided in the front portion of the middle cylinder to supply the pinpoint with the applied liquid stored in the rear portion of the middle cylinder. The valve mechanism includes a valve seat having a valve hole with a valve spindle being provided with a valve element for opening and closing the valve hole and a stretchable member for moving the valve spindle backward and forward. The stretchable member is elongated and shortened in the axial direction of the middle cylinder as the bent portions of the bent arms are bent less and more, respectively. The operating element at the rear end of the middle cylinder is operated to move the operating member forward to push the bent portions of the bent arms to elongate the stretchable member. The valve spindle is moved backward to open the valve hole to supply the applied liquid to the pinpoint.

U.S. Pat. No. 4,993,859 to Assad et al. discloses a liquid applicator including a valve body for insertion into the neck of a liquid container and defining a duct in the valve body. A resilient web is formed integrally with the valve body and extends transversely across the duct. A valve seat is located on one end of the valve body. A valve member is secured to the resilient web and has a valve biased into engagement with the valve seat at the end of the valve body. A coating member is mounted on the opposite end of the valve body. A valve stem on the valve member is located proximate the coating member for being deflected when the coating member is compressed onto an external surface to thereby unseat the valve and permit liquid to flow through the duct onto the coating member.

U.S. Pat. No. 4,685,820 to Kremer et. al. discloses an improved applicator device for applying an applicator material such as a liquid or a flowable solid to a surface. The device comprises a material container and a surface applicator for applying the applicator material to the surface. A valve is interposed between the material container and the surface applicator to permit the flow of applicator material to the surface applicator when the valve is in an open position and to inhibit the flow of applicator material to the surface applicator when the valve is in a closed position. The valve includes a valve closure having an internal closure cavity with a first end being connected to the material container and with a second end defining a surface applicator opening therein. The valve element has a distal end portion that extends through the applicator opening of the valve closure when the valve element is biased into the closed position. The surface applicator comprises the distal end portion of the valve element cooperating with the applicator opening when the distal end portion of the valve element is pressed against the surface thereby forming an annular opening for the flow of the applicator material to apply and disperse the applicator material on the surface.

U.S. Pat. No. 6,641,320 to Ballot et al. discloses a liquid applicator device comprising an applicator liquid container and a liquid dispensing mechanism. The device has a valve element movable disposed between an open position and a closed position for controlling the flow of the applicator liquid from the container. The liquid dispensing mechanism has a hollow cylindrical portion for supporting an applicator tip. The inner end of the applicator tip communicates with the valve element. An axial displacement of the applicator tip moves the valve element into the open position for enabling the applicator liquid to migrate through the applicator tip for applying the liquid to a surface. The improvement comprises a recess cooperating with a retainer for preventing the removal of the applicator tip from the liquid applicator device.

U.S. Pat. No. 8,753,027 to Ballot discloses a liquid applicator device for dispensing an applicator liquid from an applicator liquid container comprising a closure for sealing with the applicator liquid container. A sealing surface is defined in the closure and a valve is disposed within the closure. A spring is located within the closure between a spring retaining step defined in the closure and the valve for biasing the valve into sealing engagement with the sealing surface of the closure for inhibiting the flow of the applicator liquid from the applicator liquid container. A passageway defined in the closure for slidably receiving an applicator tip for engaging with the valve to enable a depression of the applicator tip to displace the valve from the sealing surface of the closure to flow applicator liquid from the applicator liquid container to the applicator tip.

U.S. Pat. No. 8,979,411 to Ballot discloses a liquid applicator is disclosed comprising a liquid container and a liquid dispensing mechanism having a valve element enabling an axial displacement of an applicator tip to move the valve element into the open position for enabling the applicator tip to apply the liquid to a surface. The improvement comprises an applicator closure having a closure coupling for coupling the applicator closure to a peripheral rim of a container. An optional shield may be secured to the applicator closure for providing protection between the applicator tip and an operator grasping the liquid container.

U.S. Pat. No. 9,211,756 to Ballot discloses a liquid applicator device is disclosed for applying a liquid from a container to a surface. A closure defining a closure aperture is secured the closure to the container. A sealing member sealingly engages with the closure mounting. The sealing member has a tubular sleeve with an applicator slidably disposed within the tubular sleeve. The applicator comprises a hollow interior with an applicator tip defined by an outer applicator portion of the applicator. A biasing member coacts between the closure and the applicator for urging the applicator to form a seal with the sealing member. A depression of the outer applicator portion against the surface displaces the applicator from the sealing member to enable the flow of the liquid from the container to the applicator tip of the applicator.

U.S. Pat. No. 9,346,072 to Ballot discloses a precision liquid applicator is disclosed for dispensing an applicator liquid from a container onto a surface. The precision liquid applicator comprises a closure defining a terminal orifice and a valve seat. A valve comprises a precision applicator tip extending through the terminal orifice and comprises a valve seal for sealing with the valve seat. A depression of the precision applicator tip onto the surface displaces the valve seal from the sealing surface for providing an annular passageway between the precision applicator tip and the terminal orifice to enable the flow of the applicator liquid onto the surface. A valve stop cooperates with a stop wall for limiting movement of the valve to control a cross-sectional area of the passageway between the precision applicator tip and the terminal orifice and for ensuring the precision applicator tip extends beyond the second end of the closure. The precision liquid applicator is suitable for applying paint into a scratch within a painted surface without excessive application of paint outside of the scratch.

U.S. Pat. No. 9,764,588 to Ballot et. al. discloses a liquid applicator device for dispensing an applicator liquid from an applicator liquid container. The liquid applicator device comprises a closure having an internal passageway for sealing with the applicator liquid container. A dispensing mechanism is disposed in the internal passageway of the closure. An applicator located in the passageway engaging with the valve element for enabling a depression of the applicator to displace the valve element from the sealing surface to enable the flow of the applicator liquid from the liquid container into the applicator. A capture extends from the valve element for grasping the applicator for inhibiting removal of the applicator from the passageway.

U.S. Pat. No. 10,576,776 to Ballot et. al. discloses a retractable liquid dispenser device comprising an outer body having a retractable mechanism slidably supporting a liquid dispenser. The liquid dispenser has a supply reservoir and a discharge reservoir with a reservoir valve disposed therebetween. A retractable valve is located in proximity to an open first end of the outer body. A first depression of the retractable actuator opens the retractable valve and moves the liquid dispenser into the extended position for enabling a depression of a distal end of the liquid applicator to open the dispensing valve to permit liquid to flow from the supply reservoir into the dispensing reservoir to dispense the applicator liquid from the distal end of the liquid applicator. A second depression of the retractable actuator moves the liquid dispenser into the retracted position and closes the retractable valve to enclose the distal end of the liquid applicator within the outer body.

Although the aforementioned U.S. Patents solved many of the problems of the prior art, other problems persisted in the use of liquid applicator devices of this type. A major problem in the design and the utilization of liquid applicator devices of this type involves the sealing of the liquid applicator device for preventing leakage of the liquid. An additional major problem in the design and the utilization of liquid applicator devices of this type involves controlling the liquid flow from the liquid applicator device.

Another object of the present invention is to provide an improved liquid applicator device for preventing leakage of the liquid.

Another object of the present invention is to provide an improved liquid applicator device which provides consistent and controllable liquid flow rate from the liquid applicator device.

Another object of this invention is to provide an improved liquid applicator device that is cost effective to produce.

The foregoing has outlined some of the more pertinent objects of the present invention. These objects should be construed as being merely illustrative of some of the more prominent features and applications of the invention. Many other beneficial results can be obtained by modifying the invention within the scope of the invention. Accordingly other objects in a full understanding of the invention may be had by referring to the summary of the invention and the detailed description describing the preferred embodiment of the invention.

### SUMMARY OF THE INVENTION

The present invention is defined by the appended claims with the specific embodiments shown in the attached drawings. For the purpose of summarizing the invention, the invention comprises a liquid applicator device for dispensing a liquid. A liquid container extends between a closed end and an open end. A closure extends from a closure inner end and a closure outer end. The closure inner end of the closure engages with the open end of the liquid container. An applicator tip extends between an inner end and an outer end. The applicator tip slidably engages within the closure outer end of the closure. A dispensing mechanism defines a valve body, an outer end and a valve body hollow. The dispensing mechanism receives the liquid from the liquid container. A valve element extends between a valve element inner end and a valve element outer end. A flared peripheral shoulder is coupled to the valve element. An expansion device engages the valve body and the valve element inner end of the valve element for impressing the flared peripheral shoulder against the valve body hollow and preventing the liquid from exiting the dispensing mechanism. The applicator tip is displaced inwardly relative to the closure outer end of the closure and displacing the valve element for disengaging the flared peripheral shoulder from the valve hollow body and permitting the flow of the liquid from the dispensing mechanism and through and around the applicator tip. The flared peripheral shoulder includes a non linear protrusion for providing a multi-angular sealing surface between the flared peripheral shoulder against the valve body hollow and preventing leakage of the liquid from the dispensing mechanism.

In another embodiment of the invention, the non linear protrusion includes a spherical cup protrusion.

In another embodiment of the invention, a valve flow regulator is coupled to the valve element for controlling the flow of the liquid from the dispensing mechanism.

In another embodiment of the invention, the valve flow regulator includes a plurality of ribs defining a plurality of flow channels. The plurality of flow channels receive the liquid and restricting the flow of the liquid to the applicator tip.

The foregoing has outlined rather broadly the more pertinent and important features of the present invention in order that the detailed description that follows may be better understood so that the present contribution to the art can be more fully appreciated. Additional features of the invention will be described hereinafter which form the subject matter of the invention. It should be appreciated by those skilled in the art that the conception and the specific embodiments may be modified for carrying out the same purposes of the present invention. It should also be realized by those skilled in the art that such equivalent constructions do not depart from the spirit and scope of the invention.

### BRIEF DESCRIPTION OF THE DRAWINGS

For a fuller understanding of the nature and objects of the invention, reference should be made to the following detailed description taken in connection with the accompanying drawings in which:

FIG. 1 is a front upper isometric view of a dispensing mechanism of the present invention;

FIG. 2 is a rear upper isometric view of FIG. 1;

FIG. 3 is a top view of FIG. 1;

FIG. 4 is a side view of FIG. 1;

FIG. 5 is a bottom view of FIG. 1;

FIG. 6 is a sectional view along line 6-6 in FIG. 4;

FIG. 7 is an exploded view of FIG. 1;

FIG. 8 is a front upper isometric view of a first valve element of the present invention;

FIG. 9 is a top view of FIG. 8;

FIG. 10 is a side view of FIG. 8;

FIG. 11 is a sectional view along line 11-11 in FIG. 9;

FIG. 12 is a side view of the first valve element of FIG. 8 in a closed position;

FIG. 13 is a view similar to FIG. 12 wherein the first valve element is in an open position upon a descending displacement;

FIG. 14 is a sectional view along line 14-14 in FIG. 12;

FIG. 15 is a sectional view along line 15-15 in FIG. 13;

FIG. 16 is a sectional view along line 16-16 in FIG. 15;

FIG. 17 is an enlarged portion of FIG. 14;

FIG. 18 is an enlarged portion of FIG. 15;

FIG. 19 is a front upper isometric view of a second valve element of the present invention;

FIG. 20 is a top view of FIG. 19;

FIG. 21 is a side view of FIG. 19;

FIG. 22 is a sectional view along line 22-22 in FIG. 20;

FIG. 23 is a similar view of FIG. 15 illustrating the second valve element of FIG. 19 in an open position;

FIG. 24 is an enlarged portion of FIG. 23;

FIG. 25 is a sectional view along line 25-25 in FIG. 23;

FIG. 26 is a front upper isometric view of a third valve element of the present invention;

FIG. 27 is a top view of FIG. 26;

FIG. 28 is a side view of FIG. 26;

FIG. 29 is a sectional view along line 29-29 in FIG. 27;

FIG. 30 is a similar view of FIG. 15 illustrating the third valve element of FIG. 26 in an open position;

FIG. 31 is an enlarged portion of FIG. 30;

FIG. 32 is a sectional view along line 32-32 in FIG. 30;

FIG. 33 is a front upper isometric view of a fourth valve element of the present invention;

FIG. 34 is a top view of FIG. 33;

FIG. 35 is a side view of FIG. 33;

FIG. 36 is a sectional view along line 36-36 in FIG. 34;

FIG. 37 is a similar view of FIG. 15 illustrating the fourth valve element of FIG. 33 in an open position;

FIG. 38 is an enlarged portion of FIG. 37; and

FIG. 39 is a sectional view along line 39-39 in FIG. 37.

Similar reference characters refer to similar parts throughout the several Figures of the drawings.

### DETAILED DISCUSSION

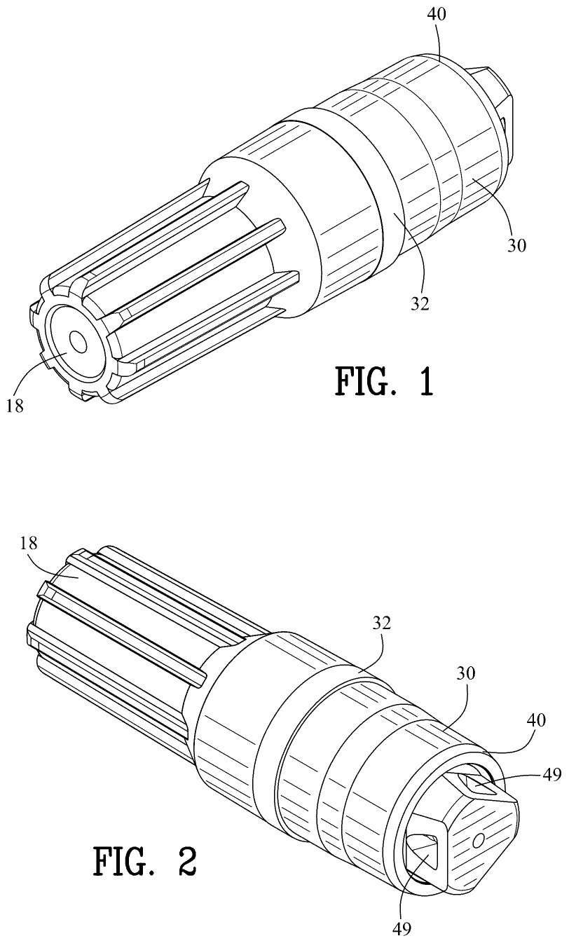

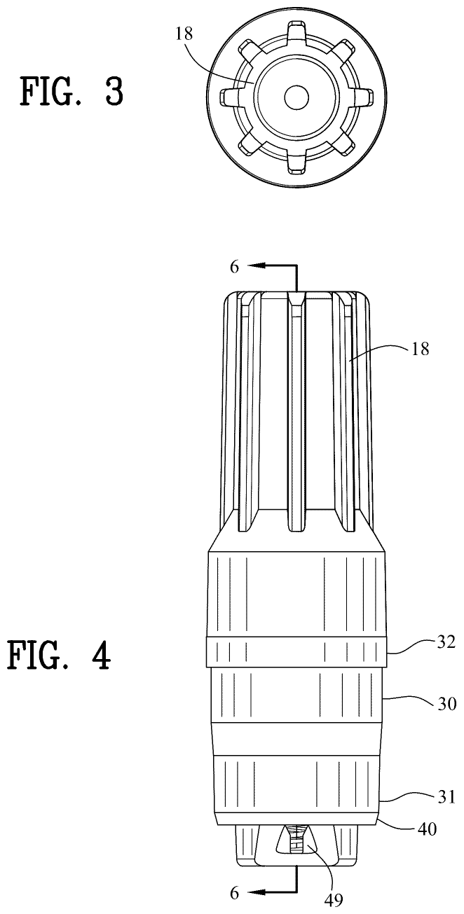

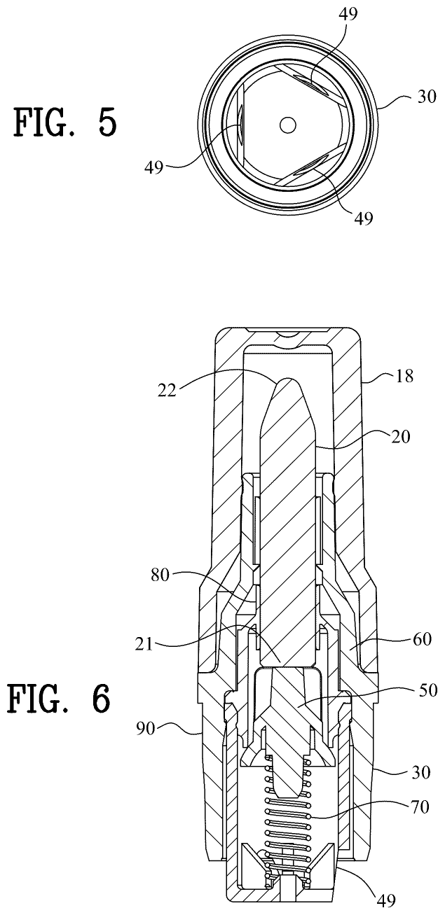

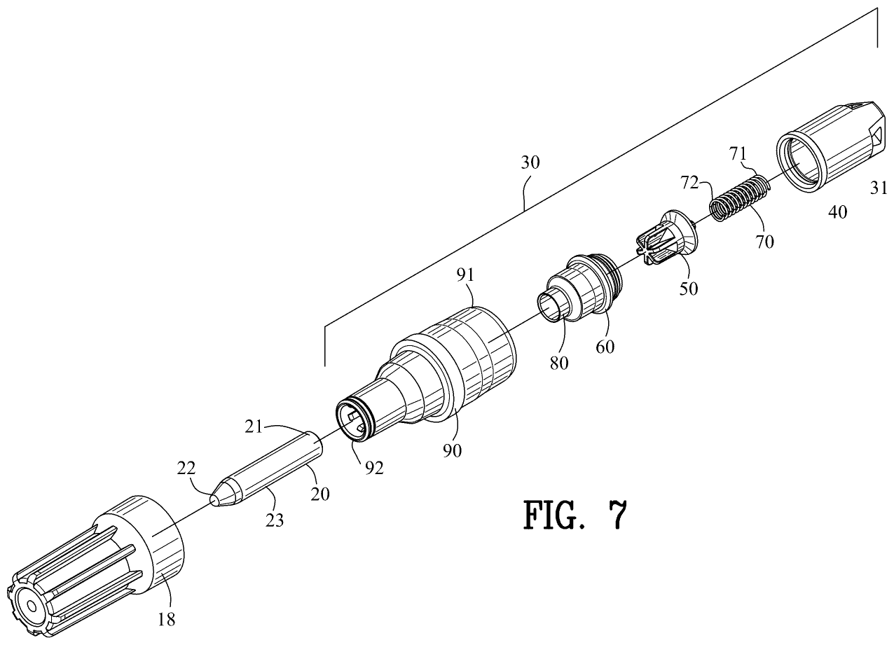

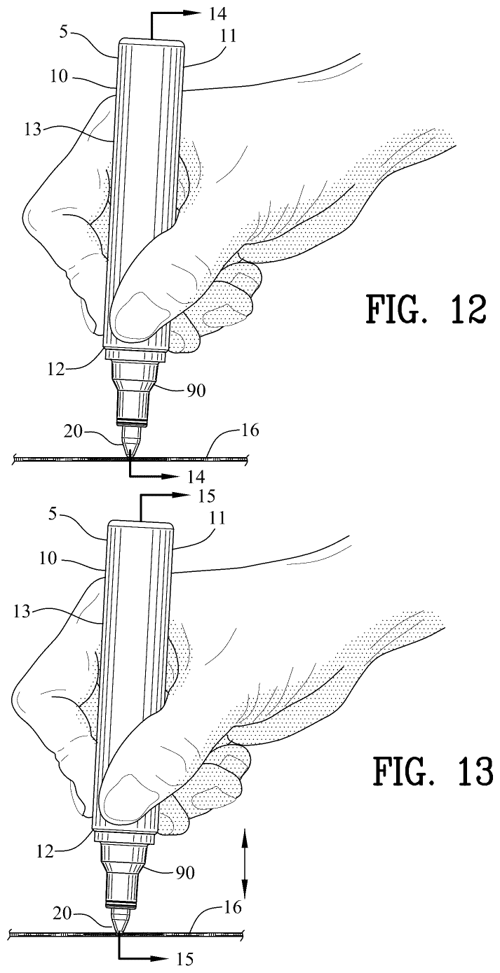

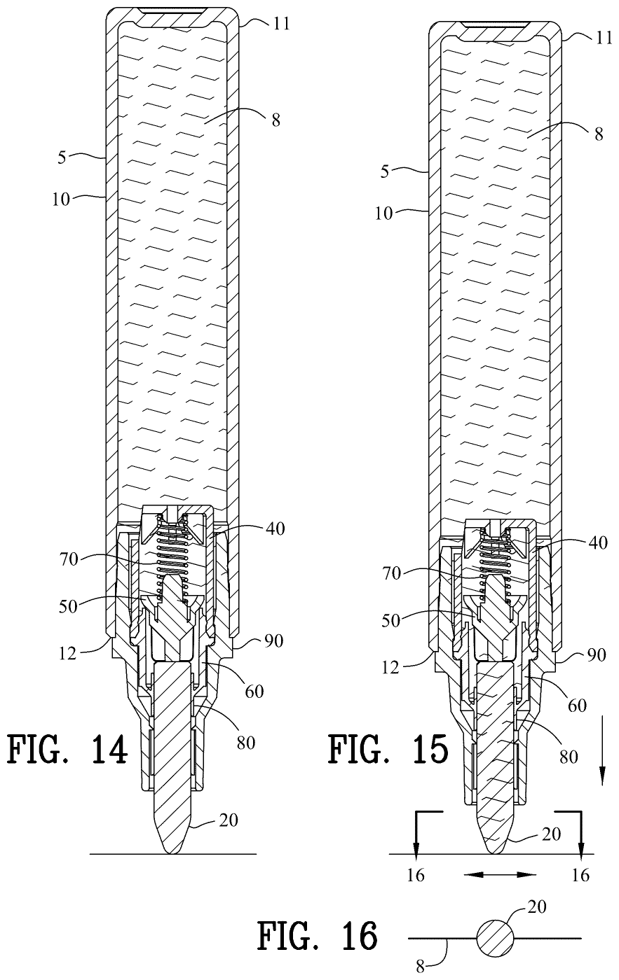

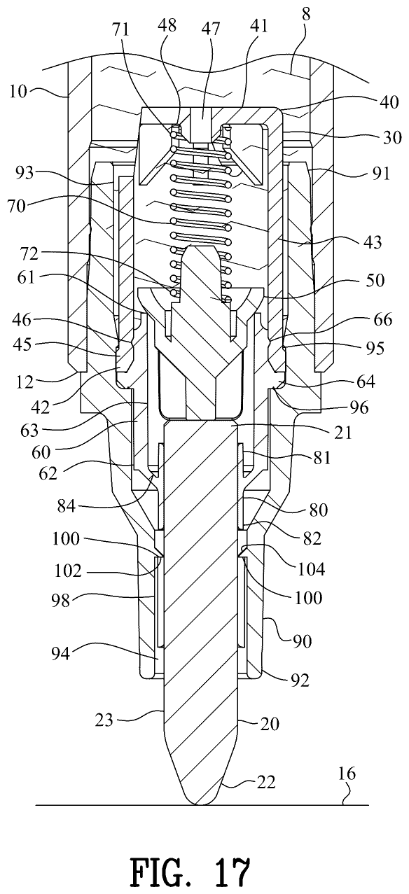

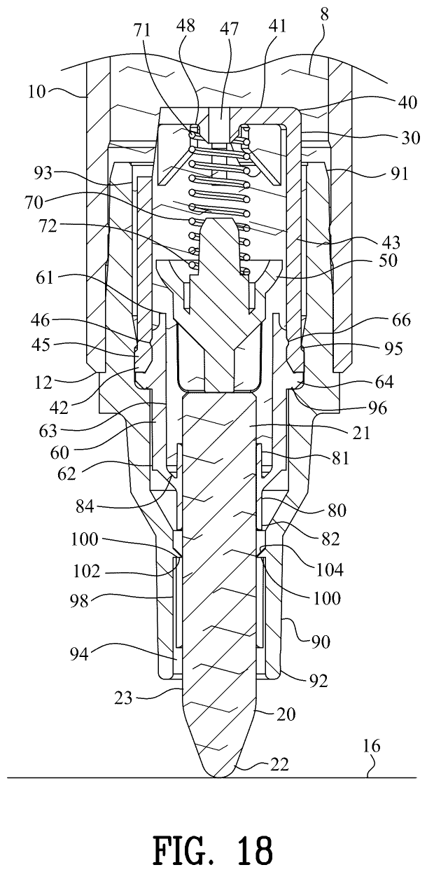

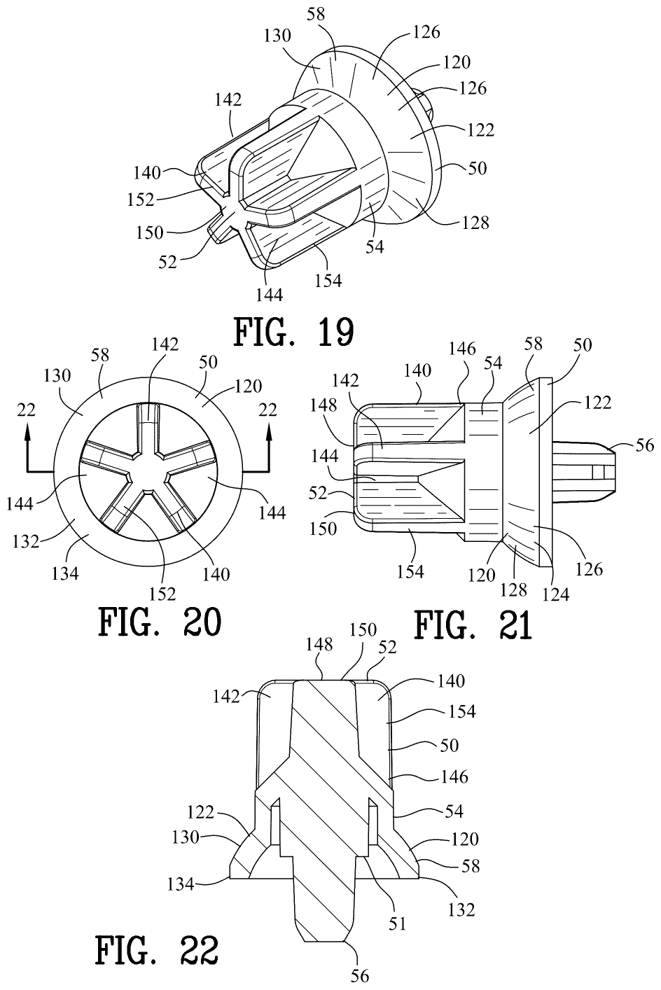

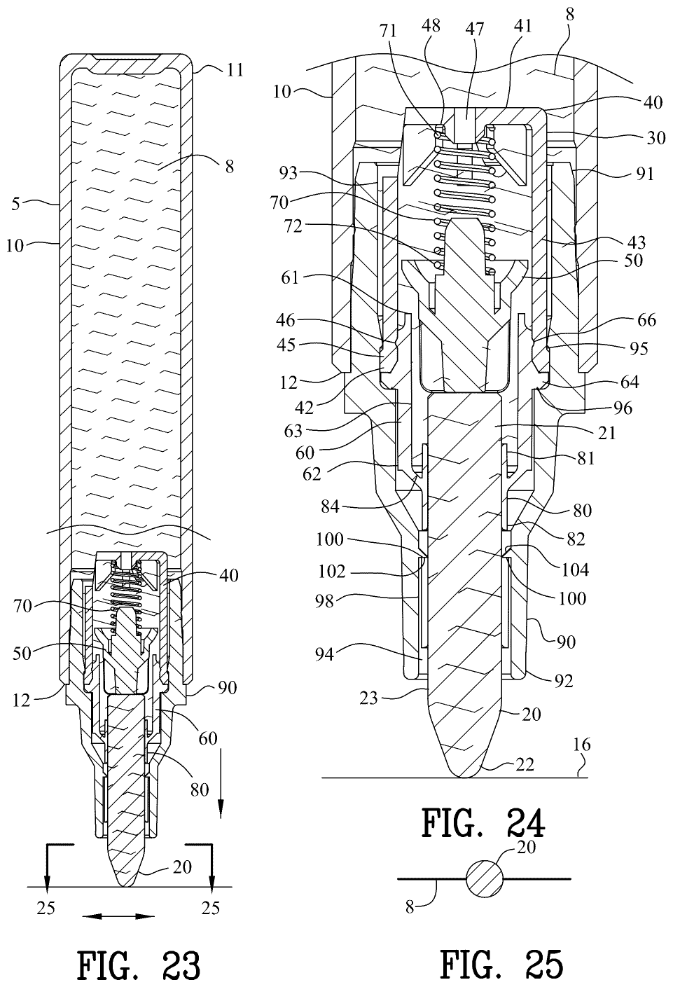

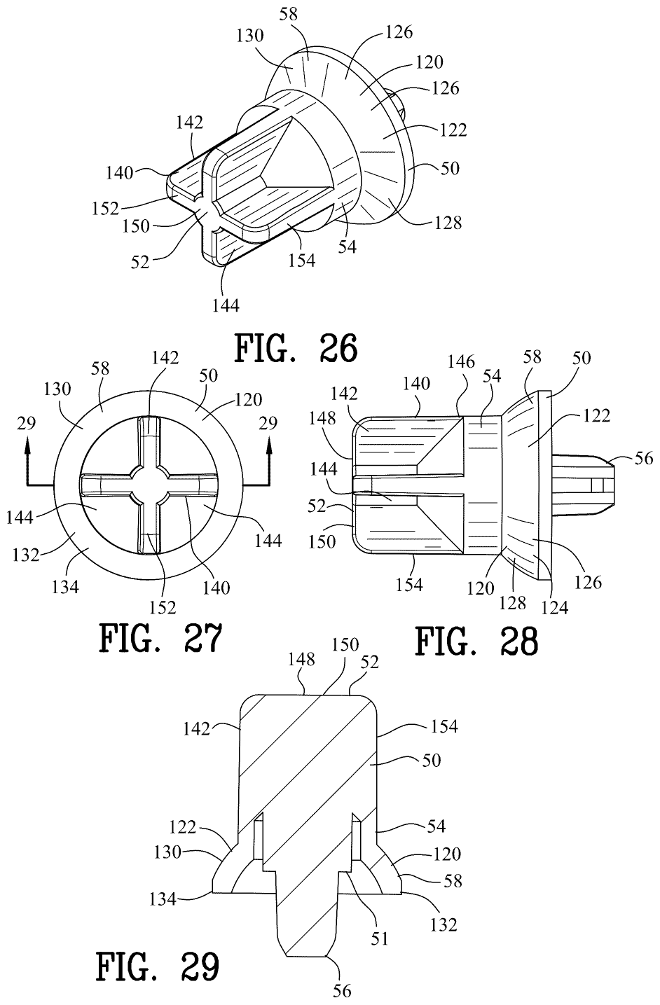

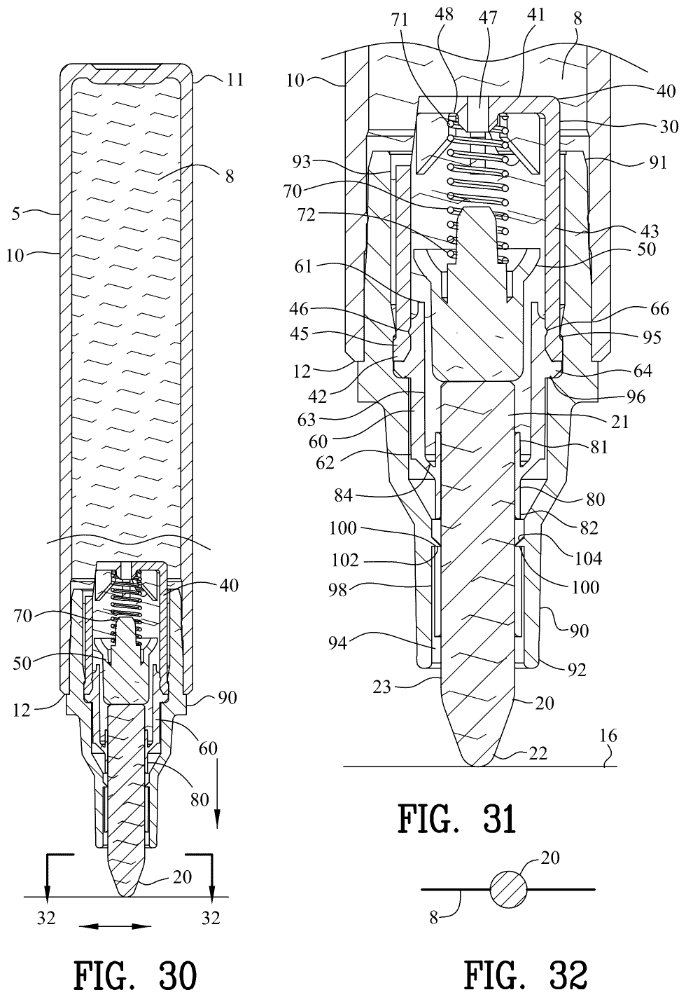

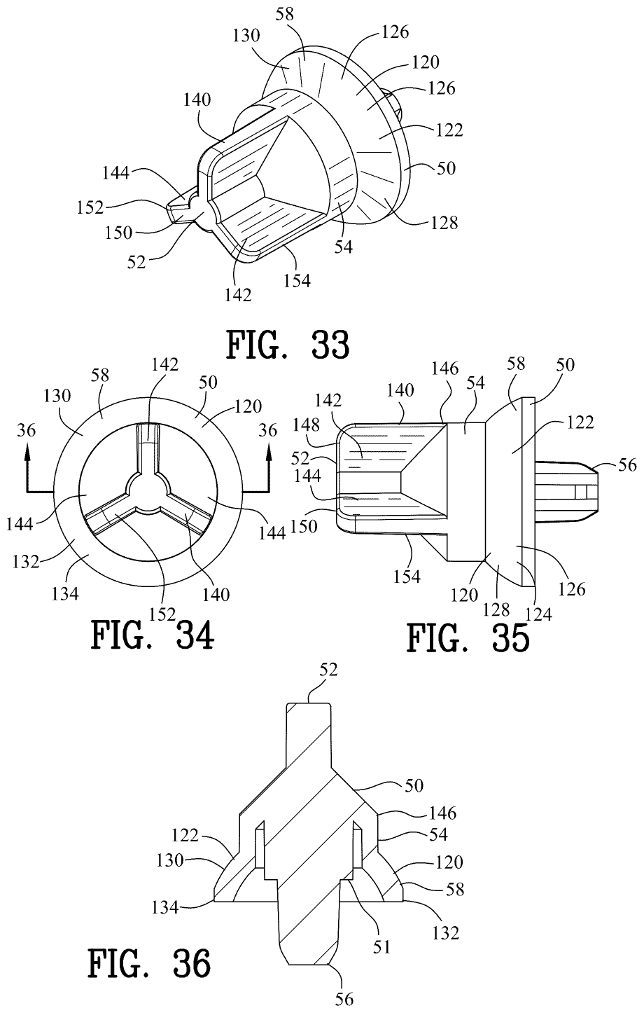

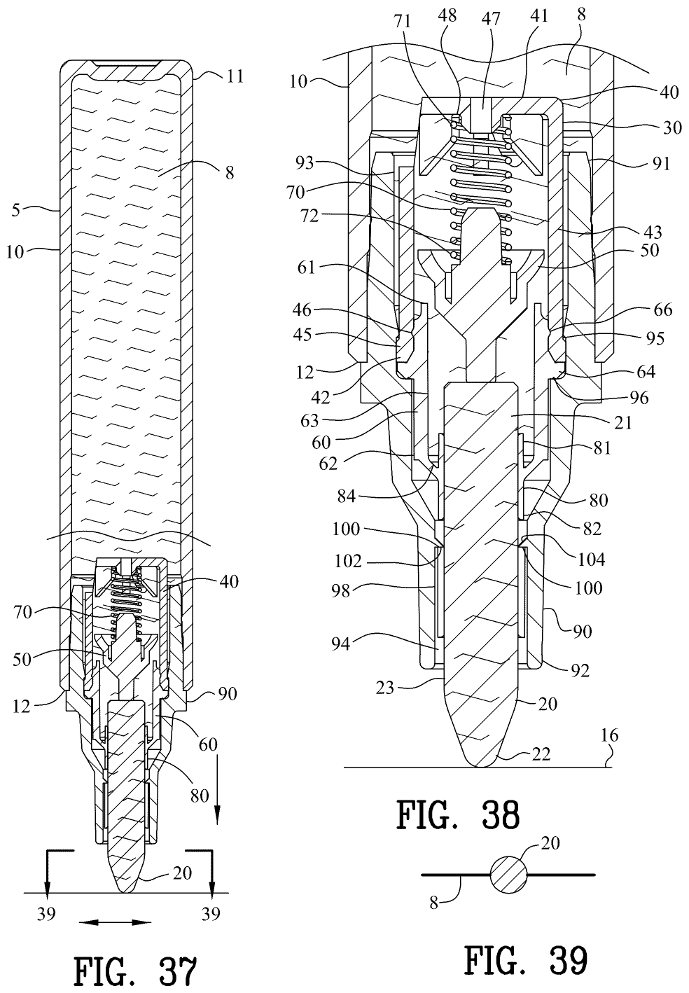

FIGS. 1-39 illustrate a liquid applicator device 5 for dispensing an applicator liquid 8 from a container 10. The liquid applicator device 5 comprises an applicator tip 20 for dispensing the applicator liquid 8 from the container 10 onto the surface 16 by a dispensing mechanism 30. As shown in FIGS. 12 and 13, the applicator tip 20 is used to dispense the applicator liquid 8 from the container 10 onto the surface 16 upon the depression of the applicator tip 20 by the applicator surface 16. The applicator tip 20 may be covered by a protective overcap 18 for preventing accidental dispensing of the applicator liquid 8.

The container 10 is preferably formed in a cylindrical shape having a closed end 11, an open end 12 and a cylindrical side wall 13. The open end 12 is adapted to introduce a quantity of the applicator liquid 8 into the container 10. The applicator liquid 8 may be a marking liquid, a lubricating liquid or any other type of liquid suitable for being dispensed by the applicator tip 20.

When the liquid applicator device 5 is used to apply a marking liquid 8, the marking liquid 8 may be formed of opaque particles suspended in a carrier material as should be well known in the art. In the event that a liquid suspension is used for the applicator liquid 8, the liquid applicator device 5 will preferably include an agitator such as a ball or a metal slug disposed within the liquid container 10. The purpose of the ball is to disburse the suspended particles of the applicator liquid 8 throughout the carrier fluid in the event that the suspended particles have become precipitated or settled from the carrier through non-use over a period of time. A preferable material for the ball is a metallic material selected to minimize any chemical reaction with the applicator liquid 8. The ball is preferably of a diameter sufficiently smaller than the inside diameter of the container 10 and of a specific gravity significantly greater than the applicator liquid 8 whereby shaking of the container 10 will readily move the ball to effect the dispersion of the suspended particles throughout the carrier fluid to improve the performance of the liquid applicator device 5.

The applicator tip 20 is a generally cylindrically shaped member extending from an inner end 21 to an outer end 22. The applicator tip 20 may be formed from a felt fiber or a brush construction. The applicator tip 20 may be rigid or flexible.

In this example of the invention, the applicator tip 20 is formed of a highly compacted fibrous material such as polyester or other similar material having analogous properties sufficient to hold the original shape when moistened with the applicator liquid 8 but adequate to pass the applicator liquid 8 from the inner end 21 to the outer end of the applicator tip 20 by capillary action.

The dispensing mechanism 30 includes an inner subassembly 31 and an outer subassembly 32. The inner subassembly 31 includes a valve body 40, a valve element 50, a valve seal 60, a spring 70 and a seal 80. The spring 70 may alternatively include other expansion devices 70. The outer subassembly 32 includes a closure 90. The closure 90 provides a support portion for positioning and slidably supporting the applicator tip 20.

FIGS. 6, 14 and 17 are sectional views of the dispensing mechanism 30 in a closed position. FIGS. 15, 18, 23, 24, 30, 31, 37 and 38 are sectional views of dispensing mechanism 30 in an open position. The valve body 40 is defined by a valve body inner end 41 and a valve body outer end 42. The valve body inner end 41 comprises a solid face whereas the valve body outer end 42 comprises an opening. A cylindrical side wall 43 extends between the valve body inner end 41 and the valve body outer end 42.

A valve body shoulder 45 is formed on the valve body outer end 42 of the valve body 40. The valve body shoulder 45 is used for affixing the valve body 40 to the closure 90 as will be described in greater detail hereinafter.

A valve body hollow 46 is defined within an inside surface of the cylindrical side wall 43. The valve body hollow 46 is used for affixing the valve body 40 to the valve seal 60 as will be described in greater detail hereinafter.

A valve body projection 47 extends from the valve body inner end 41 of the valve body 40. A circular recess 48 is defined within the valve body inner end 41 of the valve body 40 and encircles the valve body projection 47. The valve body projection 47 and the circular recess 48 cooperate to receive a first end 71 of the spring 70.

The valve body 40 is provided with a hole 49 defined within the valve body inner end 41 of the valve body 40. The hole 49 defined within the valve body 40 facilitates the flow of the applicator liquid 8 from the inside surface of the container 10 into the valve body 40.

The valve element 50 extends between a valve element inner end 51 and a valve element outer end 52. The valve element 50 defines a circumferential side wall 54. A valve element projection 56 extends from the valve element inner end 51 of the valve element 50. The valve element projection 56 receives a second end 72 of the spring 70.

The circumferential side wall 54 of the valve element 50 supports a flared peripheral shoulder 58. The outside diameter of the flared peripheral shoulder 58 is less than the inner diameter of the valve body 40 for enabling the valve element 50 to move within the valve body 40. The flared peripheral shoulder 58 includes a non linear protrusion 120 for providing a multi-angular sealing surface 122 between the flared peripheral shoulder 58 and the valve body hollow 46 for preventing leakage of the liquid 8 from the dispensing mechanism 5. The non linear protrusion 120 may include a bulbous protrusion 124, a spherical cup protrusion 126, a bell shaped protrusion 128, an arcuate shape protrusion 130 or an annular convex protrusion 132. Preferably, the valve element 50 and the non linear protrusion 120 define an integral one piece unit 134.

A peripheral shoulder which is flat or linear may result in non-complete sealing. Alignment of sealing surfaces is the predominant reason for leakage and a failure condition. The alignment of flat-to-flat, flat-to-angle, or angle-to-angle seal elements must be perfect in the planes of the static and dynamic seals. When this is the case, the seal is acceptable and non-complete sealing is highly minimized and for some fluids a leakage condition is eliminated. However, this is very difficult to repeat with perfection. A primary contributor to misalignment is the spring 70. Springs 70 are naturally flexible and the methods by which springs are wound and trimmed to length create imperfect conditions for alignment of the seals. As mentioned, the alignment of the planes of the seals is critical. As coil springs are utilized in the majority of valve systems, it is important to recognize that coil springs are produced from wire that is coiled and trimmed to length. There is a starting point and ending point to the wire where the trimming occurs. These trim points create non-uniformity at either end of the spring 70 that cause non-parallel force transfer and ‘cocking’ in the dynamic valve element that incorporates one of the two sealing surfaces. This cocking will then cause the plane of the dynamic element to shift. When the plane of the dynamic element shifts, the dynamic element cannot properly seat against the static seal element which has a fixed plane. This condition then causes very small gaps to remain open in the valve which allow very low surface tension fluids and gases from solvents to pass through these small gaps.

In order to improve valve performance and neutralize the impact of the place shift of the dynamic element, the non linear protrusion 120 is utilized on the valve element 50. The non linear protrusion 120 maintains a non-changing cross-sectional size and shape regardless of the amount of plane shift that can occur in the valve system.

The valve seal 60 includes a valve seal inner end 61 and a valve seal outer end 62 with a cylindrical sidewall 63 extending therebetween. The cylindrical side wall 63 is provided with a valve seal shoulder 64. The valve seal shoulder 64 is shown as a circumferential shoulder having a diameter greater than the remainder of the cylindrical side wall 63 of the valve seal 60. The valve seal shoulder 64 has a diameter substantially the same diameter as the diameter of the valve body 40.

The valve seal 60 includes a valve seal annular bulge 66 extending about an outer surface of the cylindrical side wall 63. The valve seal annular bulge 66 cooperates with the valve body hollow 46 of the valve body 40 for affixing the valve body 40 to the valve seal 60 as will be described in greater detail hereinafter.

The valve seal 60 may be press fit into the valve body 40 with the valve element 50 and the spring 70 located therebetween. The valve seal shoulder 64 limits the depth of penetration of the valve seal 60 into the valve body 40. The valve body hollow 46 of the valve body 40 receives the valve seal annular bulge 66 of the valve seal 60 for interlocking the valve seal 60 within the valve body 40 and for forming the inner subassembly 31 for the dispenser mechanism 30.

The outside diameter of the flared peripheral shoulder 58 of the valve element 50 is less than the inner diameter of the valve body 40 enabling the valve element 50 to move within the valve body 40. The outside diameter of the flared peripheral shoulder 58 of the valve element 50 is greater than the inner diameter of the valve seal inner end 61 of the valve seal 60 for enabling valve element 50 to form a seal with the valve seal 60.

The spring 70 biases the dispensing mechanism 30 in the closed condition as shown in FIGS. 6, 14 and 17. The flared peripheral shoulder 58 of the valve element 50 is biased into engagement with the valve seal inner end 61 of the valve seal 60 by the spring 70 to prevent the passage of the applicator liquid 8. The spring 70 is preferably formed of stainless steel or other similar material to preclude or minimize chemical reaction with the applicator liquid 8.

A seal 80 extends between a seal inner end 81 and a seal outer end 82. An intermediate mounting 84 integrally secures the seal 80 to the valve seal outer end 62 of the valve seal 60. The seal 80 provides a sliding seal with the applicator tip 20.

The applicator tip 20 extends between the inner end 21 and the outer end 22 and defines a cylindrical diameter 23 between the inner end 21 and the outer end 22. The inner end 21 of the applicator tip 20 is in direct engagement with the valve element outer end 52 of the valve element 50. The cylindrical diameter 23 of the applicator tip 20 forms a sliding seal with the seal 80.

The closure 90 extends between a closure inner end 91 and a closure outer end 92. The closure inner end 91 of the closure 90 is open for receiving a portion of the inner subassembly 31 within an internal tapered region 93 of the closure 90. The internal tapered region 93 communicates with a passageway 94 extending to the closure outer end 92 of the closure 90.

The internal tapered region 93 of the closure 90 includes a closure annular ring 95 extending inwardly from the internal tapered region 93 of the closure 90. The internal tapered region 93 of the closure 90 includes a closure shoulder 96 for cooperating with the valve seal shoulder 64 of the valve seal 60.

The closure 90 has support centering ribs 98 extending from the inner surface of the passageway 94. The support centering ribs 98 frictionally engages and supports the applicator tip 20. The support centering ribs 98 support the applicator tip 20 in a sliding engagement for enabling axial movement of the applicator tip 20 relative to the closure 90.

The internal tapered region 93 of the closure 90 receives a portion of the inner subassembly 31 with the valve seal shoulder 64 engaging the closure shoulder 96. The closure annular ring 95 of the closure 90 engages with the valve body shoulder 45 of the valve body 40 for interlocking the valve body 40 to the closure 90 thereby joining the inner subassembly 31 to the outer subassembly 32.

The applicator tip 20 is supported by support centering ribs 98 of the closure 90 and extends through the seal 80. The inner end 21 of the applicator tip 20 engages the outer end 52 of the valve element 50 whereas the outer end 22 of the applicator tip 20 extends from the closure 90.

The dispensing mechanism 30 may be joined to the container 10 by a press fit engagement. The closure 90 is tapered to be press fit inside the open end 12 of the container 10.

FIGS. 15, 18, 23, 24, 30, 31, 37 and 38 illustrate the liquid dispensing mechanism 30 in an open position. As shown in FIG. 13, a depression of the applicator tip 20 against a surface 16 will compress the spring 70 and move the valve element 50 inwardly from the valve seal 60 to move the dispensing mechanism 30 in the open condition. The flared peripheral shoulder 58 of the valve element 50 is separated from the valve seal inner end 61 of the valve seal 60 for enabling the passage of the applicator liquid 8 from the container 10 to contact the inner end 21 of the applicator tip 20. The applicator liquid 8 moves from the inner end 21 to the outer end 22 of the applicator tip 20 by capillary action.

When pressure is applied as through the depression of the applicator tip 20, the inner end 21 of the applicator tip 20 is replenished with the applicator liquid 8. The applicator liquid 8 moves by capillary action from the inner end 21 to the outer end 22 of the applicator tip 20. The applicator liquid 8 at the outer end 22 of the applicator tip 20 may be transferred to a surface 16 by marking, dabbing or a brushing action.

A retainer 100 extends from the closure 90. The retainer 100 may include a normal surface 102 and a ramp surface 104. The normal surface 102 extends generally perpendicular to the direction of movement of the applicator tip 20. The ramp surface 104 extends angularly relative to the direction of movement of the applicator tip 20.

The ramp surface 104 cooperates with the applicator tip 20 for facilitating the insertion of the applicator tip 20 into the outer end 92 of the closure 90. The ramp surface 104 of the retainer 100 prevents the inadvertent removal of the applicator tip 20 from the closure 90 by preventing an extended displacement of the applicator tip 20 relative to the closure 90.

The present invention may further include a valve flow regulator 140 coupled to the valve element 50 for controlling the flow of the liquid 8 from the dispensing mechanism 30 resulting in controlling the flow of the liquid 8 from the liquid applicator device 5. The valve flow regulator 140 may be coupled between the flared peripheral shoulder 58 and the valve element outer end 42. The valve flow regulator 140 may include a plurality of ribs 142 defining a plurality of flow channels 144. The plurality of flow channels 144 receive the liquid 8 and restrict the flow of the liquid 8 to the applicator tip 20. The plurality of ribs 142 extend from an inner rib end 146 and an outer rib end 148. The outer rib end 148 of the plurality of ribs 142 may define a linear matrix support surface 150 for equally distributing the contact area between the valve element outer end 52 and the inner end 21 of the applicator tip 20. The valve flow regulator 140 may include a geometric cross section structure 152. Preferably, the valve element 50 and the valve flow regulator 140 define an integral one piece unit 154.

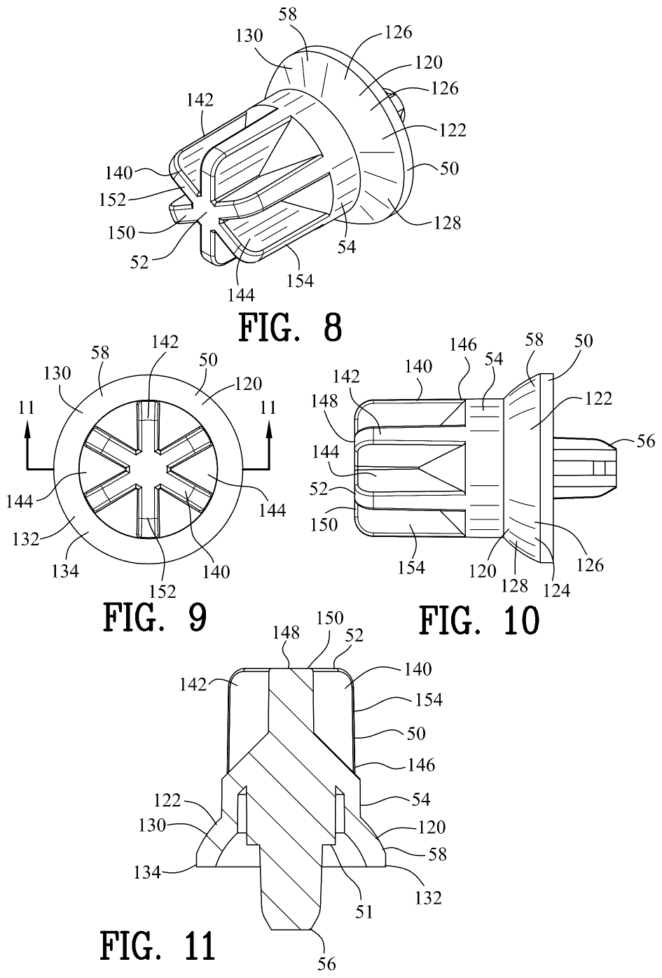

The valve flow regulator 140 may be characterized as incorporating a series of peaks and valleys along its longitudinal exterior instead of incorporating a greatly uniform outer wall. These peaks and valleys can be made in many different ways; for example, the peaks and valleys may include ribs, have a cross-section that appears to resemble a daisy, a snowflake, an asterisk, a star, a wrapped sine curve or other varied geometric feature. The valve flow regulator 140, including the longitudinal features, may be altered, optimized and tuned to interact well with fluids and the specific rheology, viscosity and surface tensions of the fluids 8. The valve flow regulator 140 assist in controlling the flow and start to aid in metering the flow of fluid into the applicator tip 20 and allow fluid to enter more closely to the center/core of the applicator tip 20. For example, as shown in FIGS. 8-11, 19-22, 33-36 and 26-29, the number of ribs 142 may be altered for increasing or decreasing the contact surface area in which the liquid 8 will engage. As the contact area increases in which the fluid 8 engages, the valve flow regulator 140 will slow the flow of the liquid 8 to the applicator tip 20. Alternatively, as the contact area decreases in which the fluid 8 engages, the valve flow regulator 140 will increase the flow of liquid 8 to the applicator tip 20.

### LIST OF REFERENCE SIGNS

5 liquid applicator device
8 applicator liquid
10 container
11 closed end
12 open end
13 cylindrical sidewall
16 surface
18 overcap
20 applicator tip
21 inner end
22 outer end
23 cylindrical diameter
30 dispensing mechanism
31 inner subassembly
32 outer subassembly
40 the valve body
41 valve body inner end
42 valve body outer end
43 cylindrical sidewall
45 valve body shoulder
46 valve body hollow
47 valve body projection
48 circular recess
49 hole
50 valve element
51 valve element inner end
52 valve element outer end
54 circumferential side wall
56 valve element projection
58 flared peripheral shoulder
60 valve seal
61 valve seal inner end
62 valve seal outer end
63 cylindrical sidewall
64 valve seal shoulder
66 valve seal annular bulge
70 spring
71 first end
72 second end
80 seal
81 seal inner end
82 seal outer end
84 intermediate mounting
90 closure
91 closure inner end
92 closure outer end
93 internal tapered region
94 passageway
95 closure annular ring
96 closure shoulder
98 support centering ribs
100 retainer
102 normal surface
104 ramp surface
120 non linear protrusion
122 multi-angular sealing surface
124 bulbous protrusion
126 spherical cup protrusion
128 bell shaped protrusion
130 arcuate shape protrusion
132 annular convex protrusion
134 integral one piece unit
140 valve flow regulator
142 plurality of ribs
144 plurality of flow channels
146 inner rib end
148 outer rib end
150 linear matrix support surface
152 geometric cross-sections structure
154 integral one piece unit

The present disclosure includes that contained in the appended claims as well as the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. A liquid applicator device for dispensing a liquid, comprising:
a liquid container extending between a closed end and an open end;
a closure extending from a closure inner end and a closure outer end;
said closure inner end of said closure engaging with said open end of said liquid container;
an applicator tip extending between an inner end and an outer end;
said applicator tip slidably engaging within said closure outer end of said closure;
a dispensing mechanism defining a valve body, an outer end and a valve body hollow;
said dispensing mechanism receiving the liquid from said liquid container;
a valve element extending between a valve element inner end and a valve element outer end;
a flared peripheral shoulder coupled to said valve element;
an expansion device engaging said valve body and said valve element inner end of said valve element for impressing said flared peripheral shoulder against said valve body hollow and preventing the liquid from exiting said dispensing mechanism;
said applicator tip displaced inwardly relative to said closure outer end of said closure and displacing said valve element for disengaging said flared peripheral shoulder from said valve hollow body and permitting the flow of the liquid from said dispensing mechanism and through and around said applicator tip; and
said flared peripheral shoulder including a non linear protrusion for providing a multi-angular sealing surface between said flared peripheral shoulder against said valve body hollow and preventing leakage of the liquid from said dispensing mechanism.

2. The liquid applicator device as set forth in claim 1, wherein said non linear protrusion includes a bulbous protrusion.

3. The liquid applicator device as set forth in claim 1, wherein said non linear protrusion includes a spherical cup protrusion.

4. The liquid applicator device as set forth in claim 1, wherein said non linear protrusion includes a bell shaped protrusion.

5. The liquid applicator device as set forth in claim 1, wherein said non linear protrusion includes an arcuate shape protrusion.

6. The liquid applicator device as set forth in claim 1, wherein said non linear protrusion includes an annular convex protrusion.

7. The liquid applicator device as set forth in claim 1, wherein said valve element and said non linear protrusion define an integral one piece unit.

8. A liquid applicator device for dispensing a liquid, comprising:
a liquid container extending between a closed end and an open end;
a closure extending from a closure inner end and a closure outer end;
said closure inner end of said closure engaging with said open end of said liquid container;
an applicator tip extending between an inner end and an outer end;
said applicator tip slidably engaging within said closure outer end of said closure;
a dispensing mechanism defining a valve body, an outer end and a valve body hollow;
said dispensing mechanism receiving the liquid from said liquid container;
a valve element extending between a valve element inner end and a valve element outer end;
a flared peripheral shoulder coupled to said valve element;
an expansion device engaging said valve body and said valve element inner end of said valve element for impressing said flared peripheral shoulder against said valve body hollow and preventing the liquid from exiting said dispensing mechanism;
said applicator tip displaced inwardly relative to said closure outer end of said closure and displacing said valve element for disengaging said flared peripheral shoulder from said valve hollow body and permitting the flow of the liquid from said dispensing mechanism and through and around said applicator tip; and
a valve flow regulator coupled to said valve element for controlling the flow of the liquid from said dispensing mechanism.

9. The liquid applicator device as set forth in claim 8, wherein said valve flow regulator is coupled between said flared peripheral shoulder and said valve element outer end.

10. The liquid applicator device as set forth in claim 9, wherein said valve flow regulator includes a plurality of ribs defining a plurality of flow channels; and
said plurality of flow channels receiving the liquid and restricting the flow of the liquid to said applicator tip.

11. The liquid applicator device as set forth in claim 10, wherein said plurality of ribs extend from an inner rib end and an outer rib end; and
said outer rib end of said plurality of ribs defining a linear matrix support surface for equally distributing the contact area between said valve element outer end and said inner end of said applicator tip.

12. The liquid applicator device as set forth in claim 8, wherein said valve flow regulator includes a geometric cross section structure.

13. The liquid applicator device as set forth in claim 8, wherein said valve element and said valve flow regulator define an integral one piece unit.

14. A liquid applicator device for dispensing a liquid, comprising:
a liquid container extending between a closed end and an open end;
a closure extending from a closure inner end and a closure outer end;
said closure inner end of said closure engaging with said open end of said liquid container;
an applicator tip extending between an inner end and an outer end;
said applicator tip slidably engaging within said closure outer end of said closure;
a dispensing mechanism defining a valve body, an outer end and a valve body hollow;
said dispensing mechanism receiving the liquid from said liquid container;
a valve element extending between a valve element inner end and a valve element outer end;
a flared peripheral shoulder coupled to said valve element;
an expansion device engaging said valve body and said valve element inner end of said valve element for impressing said flared peripheral shoulder against said valve body hollow and preventing the liquid from exiting said dispensing mechanism;
said applicator tip displaced inwardly relative to said closure outer end of said closure and displacing said valve element for disengaging said flared peripheral shoulder from said valve hollow body and permitting the flow of the liquid from said dispensing mechanism and through and around said applicator tip;
said flared peripheral shoulder including a non linear protrusion for providing a multi-angular sealing surface between said flared peripheral shoulder against said valve body hollow and preventing leakage of the liquid from said dispensing mechanism; and
a valve flow regulator coupled to said valve element for controlling the flow of the liquid from said dispensing mechanism.
